(19) United States
(12) Patent Application Publication
(10) Pub. No.: US 2026/0320931 A1
(43) Pub. Date: Oct. 15, 2026

(54) Generating an Extended Reality Environment Using Multiple Devices

(71) Applicant: Meta Platforms Technologies, LLC, Menlo Park, CA (US)

(72) Inventors: Dhwaj AGRAWAL, Redwood City, CA (US); Yash SAHAY, Palo Alto, CA (US); Ocean QUIGLEY, Oakland, CA (US); Alexander Peter DAWSON, Ottawa (CA); Yoav GOLDSTEIN, Menlo Park, CA (US)

(21) Appl. No.: 19/570,535

(22) Filed: Mar. 18, 2026

Related U.S. Application Data
(60) Provisional application No. 63/788,712, filed on Apr. 14, 2025.

(51) Int. Cl. G06T 19/00; G02B 27/01; G06T 15/08; G06T 17/20; G06V 10/25

(52) U.S. Cl. CPC G06T 19/006; G02B 27/017; G06T 15/08; G06T 17/20; G06V 10/25

(57) ABSTRACT

Aspects of the present disclosure provide technology for generating an extended reality (XR) environment using data from multiple devices. The method includes performing an initial scan of a real environment using sensors from a primary XR device, such as a head mounted device (HMD), to generate a baseline 3D model. The method then analyzes this model to define regions requiring additional data. Based on these defined regions, the method identifies specific areas of interest and guides a user to capture high-resolution images of these areas using a secondary mobile device. The captured images are received and integrated with the baseline model to generate an updated, high-fidelity XR environment. This hybrid approach combines the spatial awareness of an HMD with the high-quality imaging of a mobile device to create a complete and detailed digital twin of a physical space more efficiently.

### CROSS-REFERENCE TO RELATED APPLICATIONS

This application claims priority to U.S. Provisional Patent Application No. 63/788,712, titled "Generating a Virtual Environment from a Mixed Reality Device," filed Apr. 14, 2025, which is herein incorporated by reference in its entirety.

### TECHNICAL FIELD

The present disclosure is generally directed to generating an extended reality environment and, more particularly, generating an extended reality environment, using input from multiple devices.

### BACKGROUND

Extended reality devices are configured to interact in extended reality environments. Generating extended reality environments requires computational resources and multiple images to generate the environment. In the current technology, the extended reality environment can be initiated with a baseline three-dimensional mesh that must be augmented to fully complete the extended reality environment. When generating an extended reality environment, the process can be cumbersome and require multiple images. A viable replication of an extended reality environment may also require a level of skill for the user who generates the environment. This level of skill is necessary to ensure that the appropriate dimensions and spatial orientations can be acquired to generate the environment.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a extended reality headset which can be used in some implementations of the present technology.

FIG. 2C is a wire diagram illustrating controllers which, in some implementations, a user can hold in one or both hands to interact with an extended reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for generating an extended reality environment by using data from a combination of devices.

FIG. 6 is a conceptual diagram illustrating an example of a view through an extended reality device with virtual object overlays providing instruction for environment scanning.

FIG. 7 is a conceptual diagram illustrating a mount device coupling a mobile device to an extended reality device controller.

FIGS. 8A-8C are conceptual diagrams illustrating an example of capturing a physical space using multiple capture devices.

The techniques introduced here may be better understood by referring to the following Detailed Description in conjunction with the accompanying drawings, in which like reference numerals indicate identical or functionally similar elements.

### DETAILED DESCRIPTION

Some room scanning techniques include a mobile device scan which utilizes a mobile phone to capture images of the user's room. However, since the world is viewed through the phone, users may perform quicker movements than when looking around naturally, increasing the likelihood of stumbling or moving objects in the room, which can render the entire scan ineffective. Completing a high-quality scan in a typical room can take 20-30 minutes. Other room scanning techniques include a head mounted device (HMD) scan, which is a scan conducted using the HMD, as the device is equipped with an array of cameras capable of capturing data. However, scanning solely with the HMD has its limitations, including some related to the quality of the images produced and others due to the strain of moving the user's head over time, which also makes it more challenging to capture low and high surfaces that would otherwise be easier to capture. Thus, generating an extended reality environment from a real space, using prior technologies, can be a cumbersome and resource-intensive process. For example, using only a mobile device can produce high-quality images but is slow, requires the user to navigate the world through a small screen, and increases the risk of incomplete scans. Conversely, while using only a head mounted device (HMD) provides a more natural, hands-free scanning motion, it suffers from lower-quality images and difficulty in capturing surfaces at extreme angles, such as those that are very low or very high. These limitations often require a user to have considerable skill and patience to generate a viable and accurate replication of a real-world environment.

The disclosure addresses the technical problem of generating an extended reality environment by using data from a combination of devices, such as a combination of a mobile device and a head mounted device (HMD) or a combination of a mobile device, an HMD, and a controller. By integrating the use of an extended reality device for an initial, broad scan and a mobile device for a targeted, detailed scan, users with less experience can create highly detailed and accurate environment scans. The disclosed method improves the quality of the environment scan by guiding the user from a first-person, wide field of view to capture specific, relevant places in a more natural way, providing real-room guidance. This is achieved by implementing synchronization between images captured on the extended reality device and the mobile device, allowing the system to intelligently fuse the data from both sources into a single, high-fidelity extended reality environment.

The method for generating an extended reality environment can be initiated by performing an initial scan of a real environment. During the initial scan, a user can wear an extended reality device, wherein the extended reality device has multiple cameras. In a further aspect, a user can enter a real space such as an office or warehouse. In the attempt to convert the office or warehouse into an extended reality environment, the user can walk around the respective space while the extended reality device scans the room using the associated cameras integrated into the extended reality device. The processor associated with the extended reality device can generate an initial mock-up of the extended reality environment. In further aspects, the mock-up may comprise a three-dimensional mesh or Gaussian splat model.

The extended reality device can determine which additional spacing and dimensional data is needed to fully define the virtual reality space. Once the additional spacing and dimensional data is determined, the extended reality device can determine the images required to provide the additional spacing and dimensional data. In an aspect, the extended reality device can be in communication with an application running on a mobile device. The application on the mobile device can provide instructions to a user for manipulating the camera of the mobile device to capture the necessary images required for the additional spacing and dimensional data. In a further aspect, the application operating on the mobile device can include a user interface to provide instructions to the user on how to orient the user device in space such that the proper image is captured.

In another aspect, the extended reality device can comprise a controller that is structured to couple with a mobile device such that the user can use the ergonomic features of the controller to more easily capture images with the coupled mobile device. In another embodiment, the instructions provided to the user can comprise audible verbal instructions. In yet another embodiment, the instructions provided to the controller can include multiple auxiliary indicators demonstrating the variance between the current orientation of the mobile device camera to the orientation consistent with the instructions. The auxiliary indicators on the controller or the mobile device can provide a tactile response, such as a vibration indicator, or audible indicator, such as a beep. The model can proceed with generating an updated extended reality environment based on the initial extended reality environment and the multiple images associated with the multiple scanning directions.

Embodiments of the disclosed technology may include or be implemented in conjunction with an extended reality system. Extended reality, artificial reality, or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Extended reality content may include completely generated content or generated content combined with captured content (e.g., real-world photographs). The extended reality content may include video, audio, haptic feedback, or some combination thereof, any of which may be presented in a single channel or in multiple channels (such as stereo video that produces a three-dimensional effect to the viewer). Additionally, in some embodiments, extended reality may be associated with applications, products, accessories, services, or some combination thereof, that are, e.g., used to create content in an extended reality and/or used in (e.g., perform activities in) an extended reality. The extended reality system that provides the extended reality content may be implemented on various platforms, including a head mounted device (HMD) connected to a host computer system, a standalone HMD, a mobile device or computing system, a "cave" environment or other projection system, or any other hardware platform capable of providing extended reality content to one or more viewers.

"Virtual reality" or "VR," as used herein, refers to an immersive experience where a user's visual input is controlled by a computing system. "Augmented reality" or "AR" refers to systems where a user views images of the real world after they have passed through a computing system. For example, a tablet with a camera on the back can capture images of the real world and then display the images on the screen on the opposite side of the tablet from the camera. The tablet can process and adjust or "augment" the images as they pass through the system, such as by adding virtual objects. "Mixed reality" or "MR" refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Extended reality,” "Artificial reality," "extra reality," or "XR," as used herein, refers to any of VR, AR, MR, or any combination or hybrid thereof.

The disclosed technology provides a specific technological improvement over prior art computing systems for generating three-dimensional models of physical spaces. Prior art systems typically rely on a single capture device, forcing a trade-off. Systems using only HMDs capture good spatial data but often produce low-texture models due to lower-resolution cameras and physical user strain, leading to incomplete data for high or low surfaces. Systems using only mobile phones can capture high-resolution textures but suffer from poor spatial tracking, slow capture times, and a cumbersome user experience that often results in misaligned or incomplete scans. These prior art systems are inefficient, requiring either excessive processing to stitch together poor-quality data or prolonged user interaction, both of which consume significant computational resources (CPU, GPU, memory) and battery life.

The technology disclosed herein overcomes these problems by creating a new type of computer-implemented system that is specifically rooted in the coordinated operation of multiple, distinct computing devices. The system uses a processor to execute a specific method that first leverages the strengths of an HMD's computing and sensor suite for rapid, spatially-aware environment mapping. Then, it performs a computational analysis on the resulting 3D model to identify specific regions of data insufficiency. Finally, it establishes a synchronized communication channel with a separate computing device (e.g., a mobile phone) to provide real-time, computer-generated guidance, directing the user to capture high-resolution image data only where it is needed. This is not an analog to a human process; it is a specific computing architecture and method that improves the functioning of the computer system itself by optimizing the data capture process, reducing overall processing load, minimizing user error, and ultimately producing a higher-fidelity digital asset more efficiently than was previously possible.

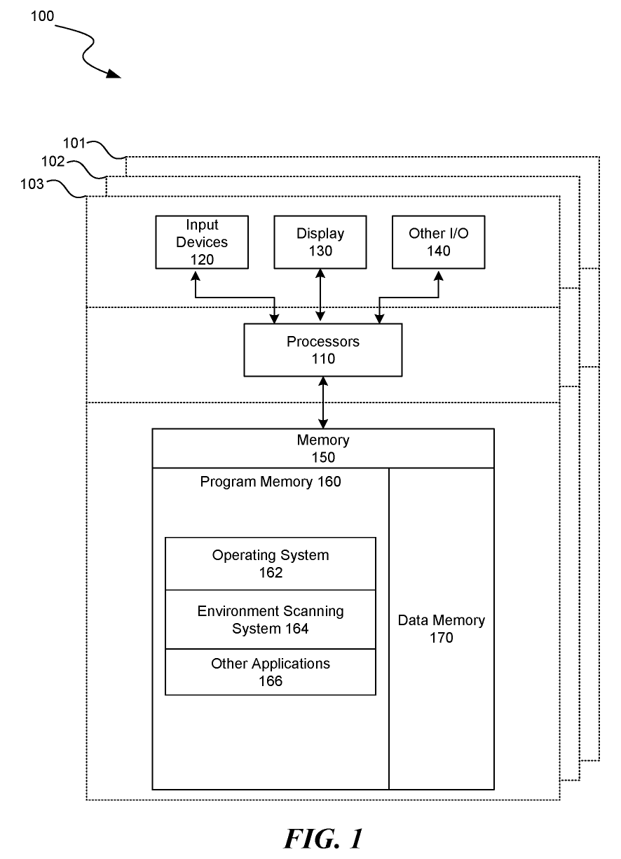

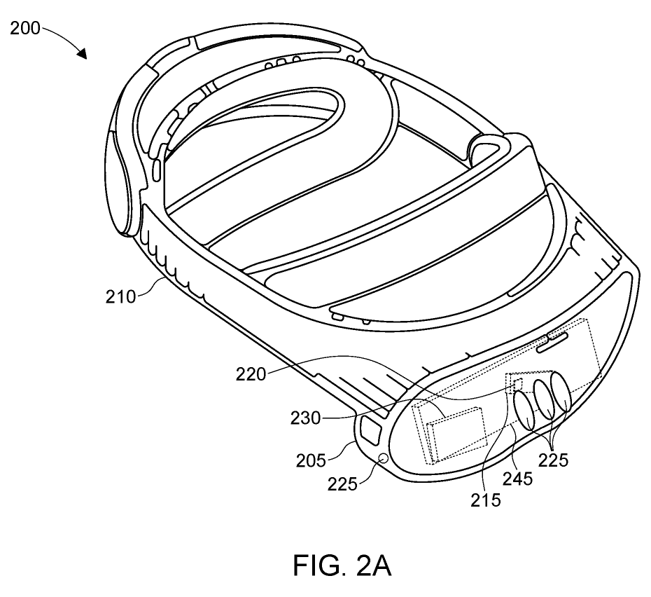

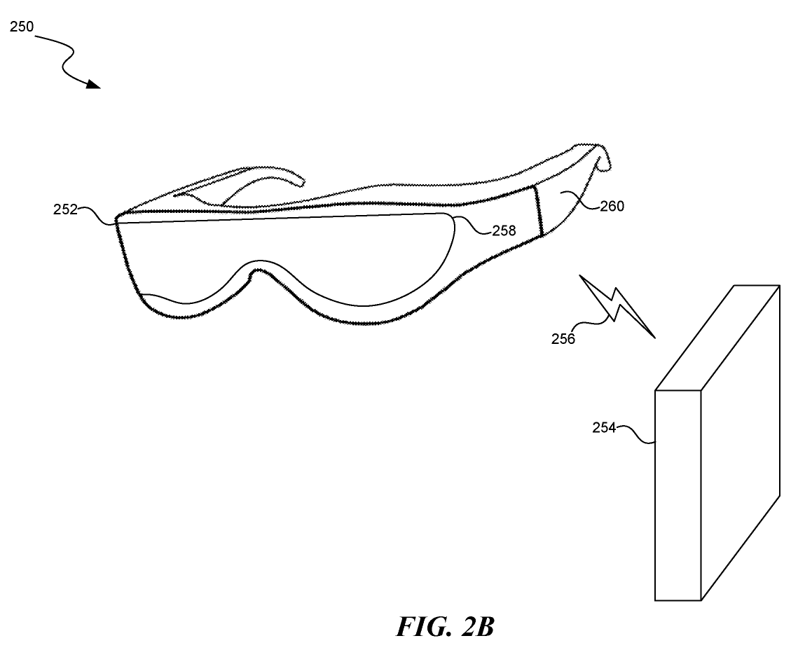

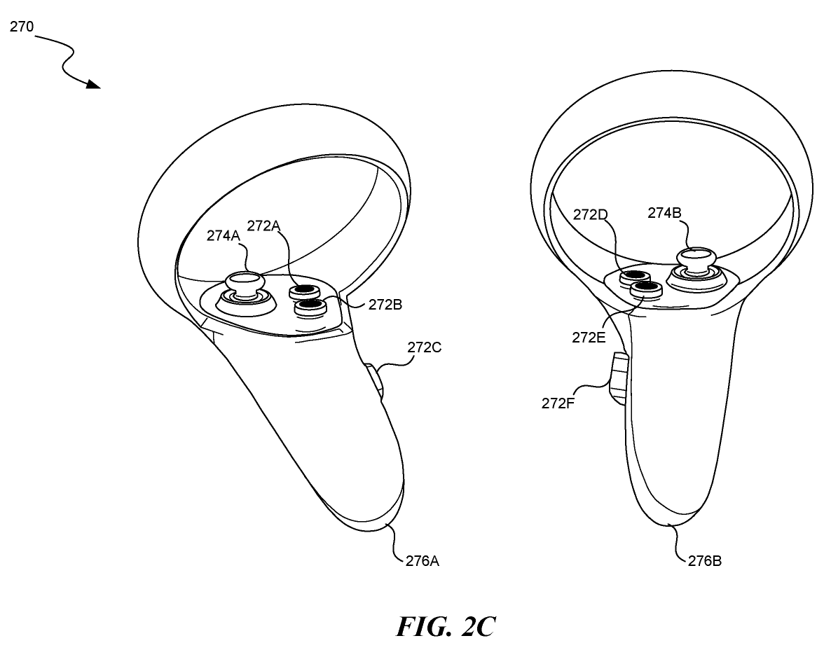

Several implementations are discussed below in more detail in reference to the figures. FIG. 1 is a block diagram illustrating an overview of devices on which some implementations of the disclosed technology can operate. The devices can comprise hardware components of a computing system 100 that generates an extended reality environment using data from multiple devices. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, environment scanning system 164, and other application programs 166. Memory 150 can also include data memory 170 that can include, e.g., environment images, telemetry data, 3d mesh data, depth data, configuration data, settings, user options or preferences, etc., which can be provided to the program memory 160 or any element of the computing system 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to perform steps as shown and described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head mounted device (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an extended reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200. In some implementations, cameras 225 can also capture images of parts of the user, such as hands, feet, or other body parts, and use these images to track the position of these body parts. In some cases, this hand / body tracking can be performed in addition or alternatively by worn devices, such as a wrist band, ring, glove, etc. Additional details on user tracking are provided below in relation to FIG. 2C.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects. In some implementations, the cameras can capture images of parts of the user, such as hands, feet, or other body parts, and use these images to track the position of these body parts. In some cases, this hand / body tracking can be performed in addition or alternatively by worn devices, such as a wrist band, ring, glove, etc. Additional details on user tracking are provided below in relation to FIG. 2C.

FIG. 2C illustrates controllers 270 (including controller 276A and 276B), which, in some implementations, a user can hold in one or both hands to interact with an extended reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction. In some implementations, images captured of the user’s hands can be used to determine a pose and/or position of the hands, which can then be translated to user input and/or to control position or pose of an avatar representing the user in an extended reality environment. For example, various machine learning systems (e.g., trained using synthetic hand pose/position and location information or trained using hand images paired with pose and position data from other tracking devices such as external cameras or tracking sensors) can receive image representations and translate them into hand pose and/or position information. In some implementations, one or more other controllers shapes and configurations can also be used, such as a wrist worn band that translates electrical signals projected into the user’s wrist and then read to interpret a hand pose. For example, such electrical signals can be interpreted by a machine learning system that has been trained using such read electrical signals paired with poses determined by a worn glove or other pose data. In some implementations, such a band can also include various tracking systems, such as an IMU unit, cameras for inside-out tracking, etc.

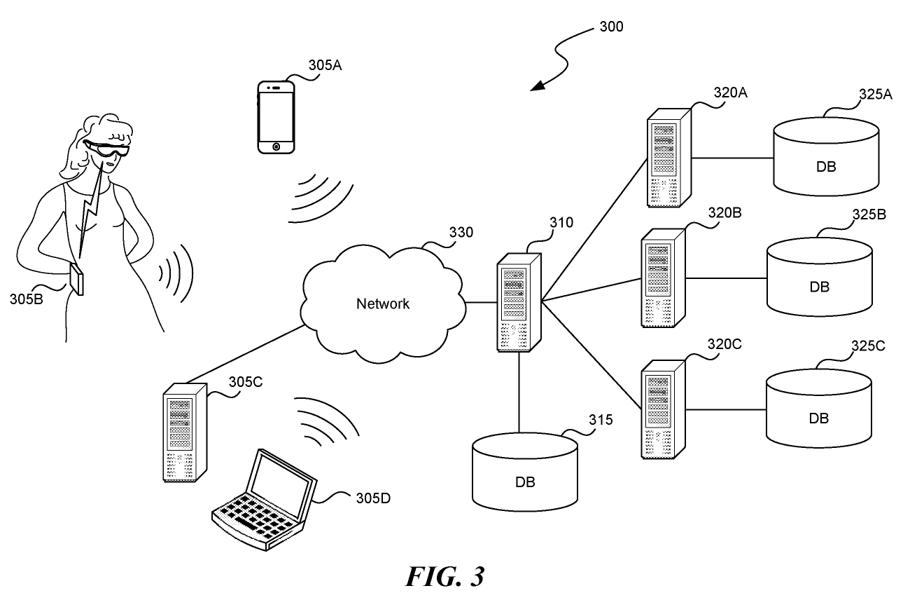

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

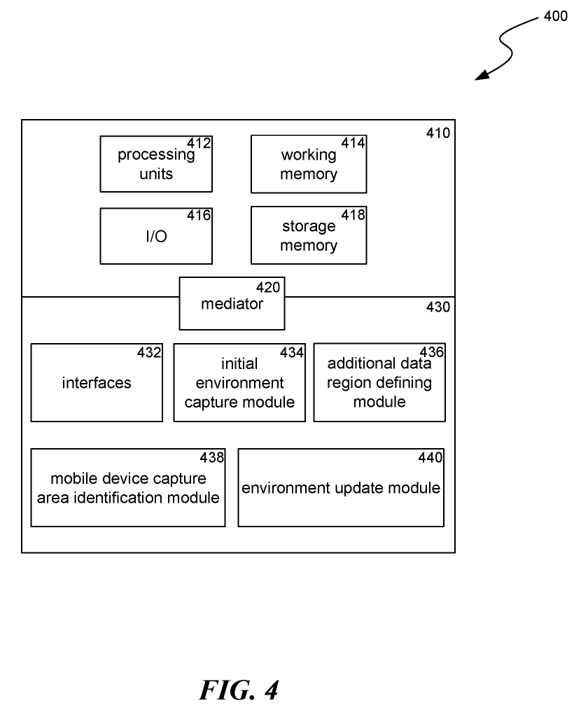

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for generating an extended reality environment by using data from a combination of devices. Specialized components 430 can include an initial environment capture module 434, an additional data region defining module 436, a mobile device capture area identification module 438, and an environment update module 440, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

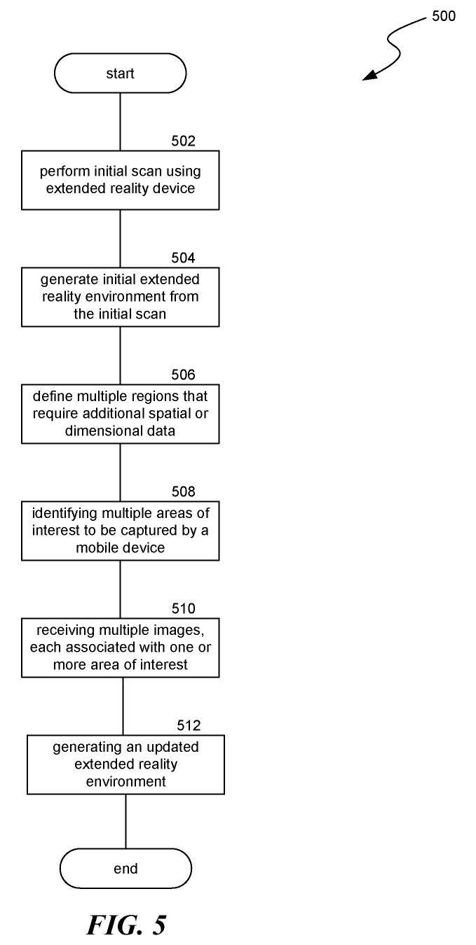

The initial environment capture module 434 is configured to perform and process the initial scan of a real environment using sensors from the extended reality device. This module utilizes data from sensors like cameras, depth sensors, and IMUs to generate a baseline three-dimensional model of the surrounding space. This initial model serves as the foundation for the extended reality environment. The module can be configured to generate different types of models, such as a point cloud, a 3D mesh, or a Gaussian splat model, depending on the application's requirements. Additional details for component initial environment capture module 434 can be found below with reference to blocks 502 and 504 of FIG. 5.

The additional data region defining module 436 is configured to analyze the initial extended reality environment and define specific regions that require additional spatial or dimensional data. This module assesses the generated 3D model for areas of low quality, such as regions with low texture detail, complex geometry that was poorly captured, or insufficient data due to poor lighting or occlusion during the initial scan. By identifying these deficiencies, the module determines where supplemental, high-resolution data is needed to enhance the fidelity of the final environment. Additional details for component additional data region defining module 436 can be found below with reference to block 506 of FIG. 5.

The mobile device capture area identification module 438 is configured to identify, based on the defined regions from module 436, multiple specific areas of interest to be captured by a mobile device. This module translates the identified data deficiencies into actionable instructions for the user. It generates guidance cues, which can be visual overlays in the HMD, on-screen prompts on the mobile device, audible instructions, or haptic feedback, to direct the user to precisely position the mobile device's camera to capture the required images. This ensures that the supplemental data collection is efficient and targeted only at the areas needing improvement. Additional details for component mobile device capture area identification module 438 can be found below with reference to block 508 of FIG. 5.

The environment update module 440 is configured to receive the multiple images from the mobile device and generate an updated, high-fidelity extended reality environment. This module takes the high-resolution images associated with the areas of interest and integrates them with the initial baseline model. It performs data fusion, aligning the new image data with the existing 3D geometry to enhance texture, refine object shapes, and fill in missing details. The output of this module is the final, complete extended reality environment that combines the broad spatial accuracy of the initial scan with the detailed visual information from the mobile device capture. Additional details for component environment update module 440 can be found below with reference to blocks 510 and 512 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations of the present technology for generating an extended reality environment by using data from a combination of devices. In some implementations, process 500 can be performed in response to an instructions from a user seeking to create a digital twin of a real-world space, such as a room or office. Process 500 can be performed by an XR system, which may comprise an extended reality device like an HMD in conjunction with a mobile device like a smartphone, operating in communication with each other. The process leverages the unique capabilities of each device to create a high-quality XR environment more efficiently than using a single device alone.

At block 502, the process 500 can perform an initial scan of a real environment using sensors from an extended reality device. A user wearing the XR device, such as an HMD 200, can walk around the physical space. The device's integrated sensors (which may include one or more RGB cameras, depth sensors (e.g., LiDAR, time-of-flight sensors), inertial measurement units (IMUs), etc.), capture data about the geometry and appearance of the environment. This initial scan is typically rapid and focuses on capturing the broad spatial layout of the room, including walls, floor, ceiling, and large objects. The hands-free nature of an HMD allows this scan to be performed naturally and quickly.

At block 504, the process 500 can generate an initial extended reality environment from the data acquired during the initial scan. The XR device, or a communicatively connected computing system, processes the sensor data to construct a baseline 3D model of the space. In some implementations, this initial environment comprises a three-dimensional mesh, which is a collection of vertices, edges, and faces that defines the shape of polyhedral objects in 3D space. In other implementations, the environment may be represented as a Gaussian splat model, which uses a collection of 3D Gaussians to represent the scene, offering a different trade-off between rendering speed and quality. This initial model provides a foundational, but potentially low-detail, digital replica of the environment.

At block 506, the process 500 can define multiple regions of the initial extended reality environment that each require additional spatial and/or dimensional data. After the baseline model is generated, the system analyzes it to identify areas of insufficiency. These regions may be characterized by low-resolution textures, incomplete geometric data (e.g., areas that were occluded during the scan), or surfaces at extreme angles that were difficult for the HMD's sensors to capture accurately. For example, the system might flag the text on a book, the detailed pattern of a carpet under a table, or the surface of a high ceiling as regions requiring enhancement.

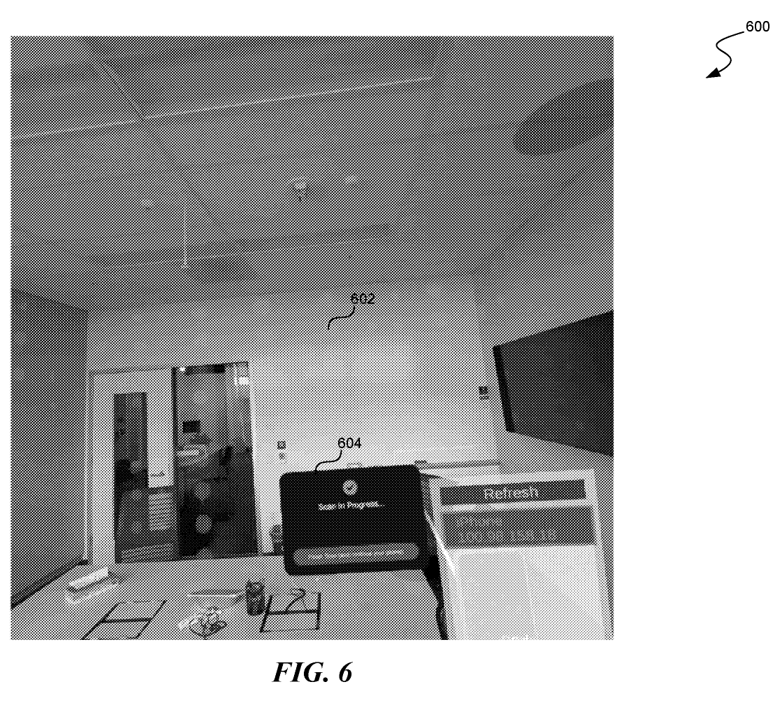

At block 508, the process 500 can identify, based on the defined regions, multiple areas of interest to be captured by a mobile device. The system translates the list of deficient regions into a set of specific capture targets for the user. It then generates guidance cues to direct the user to these areas of interest. In some implementations, this guidance is visual, such as virtual overlays or markers visible through the HMD (as shown in FIG. 6) or on the mobile device's screen, indicating where to point the camera. In other implementations, the guidance may be audible ("point your phone at the floor beneath the chair") or tactile (e.g., a vibration from a controller 276A/B when the mobile device is correctly oriented). This guided approach ensures that the user efficiently captures the exact data needed to improve the model.

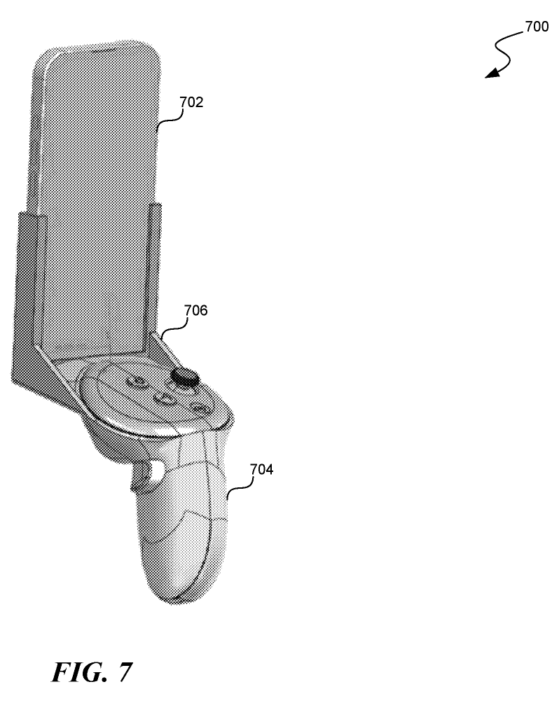

At block 510, the process 500 can receive, from the mobile device, multiple images, with each image associated with at least one of the multiple areas of interest. As the user follows the guidance and captures images with the mobile device's high-resolution camera, the images are transmitted back to the XR system over a wireless communication channel. In some implementations, the spatial orientation of the mobile device is synchronized with the extended reality device. A texture data structure can be used to capture i) both the points on the mesh where the scene was captured and ii) the angle data for each of these points. This can be achieved automatically through visual-inertial odometry or aided by a physical mount (e.g., as illustrated in FIG. 7) that couples the mobile device to a tracked controller, establishing a known spatial offset. This synchronization is used to correctly map the received high-resolution images onto the 3D model.

At block 512, the process 500 can generate an updated extended reality environment based on the initial extended reality environment and the multiple images associated with the multiple areas of interest. The system performs a data fusion operation, integrating the high-resolution texture and detail from the mobile device's images into the baseline 3D model. This may involve texture mapping, mesh refinement, or updating the parameters of a Gaussian splat model. The result is a final, high-fidelity extended reality environment that combines the spatial accuracy of the HMD scan with the visual detail of the mobile device's camera.

FIG. 6 is a conceptual diagram illustrating an example of a view 600 through an extended reality device with virtual object overlays providing instruction for environment scanning. The view 600 shows a real-world environment, such as an office, as seen by the user. The system renders virtual guidance cues, such as the grid of virtual dots on the ceiling and the dots 602 on the far wall. These overlays represent areas of interest that the system has identified as requiring additional, high-resolution image capture by a secondary device, such as a mobile phone. By displaying these cues within the user's first-person field of view, along with an instruction dialog 604, the system intuitively and precisely directs the user where to point the mobile device to capture the necessary data to enhance the XR environment.

FIG. 7 is a conceptual diagram 700 illustrating a mount device 706 coupling a mobile device 702 to an extended reality device controller 704. In this implementation, the mount 706 physically connects the mobile device 702 to the controller 704, establishing a fixed and known spatial relationship between the controller, which is tracked in 3D space by the XR system, and the camera of the mobile device. This configuration allows the system to apply a precise translation during the capture experience, enabling the presentation of guidance that appears to emerge directly from the mobile device itself. This improves the ergonomics and precision of the guided capture process, as the user can more easily and accurately align the mobile device 702’s camera with the areas of interest identified by the system. In some implementations, instead of using a controller mount, alignment is done automatically based on data (e.g., IMU, depth data, etc.) from the mobile device 702.

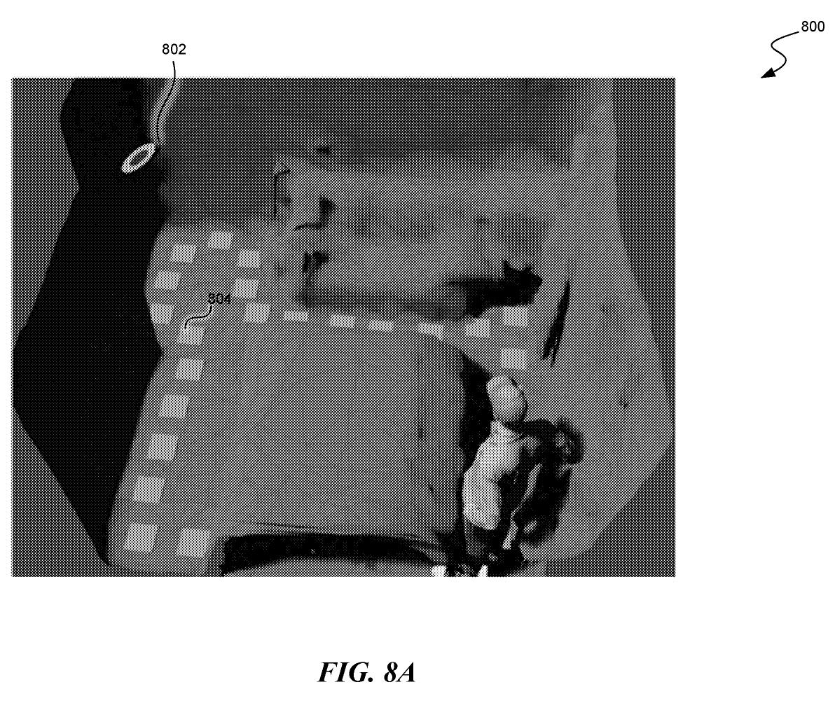

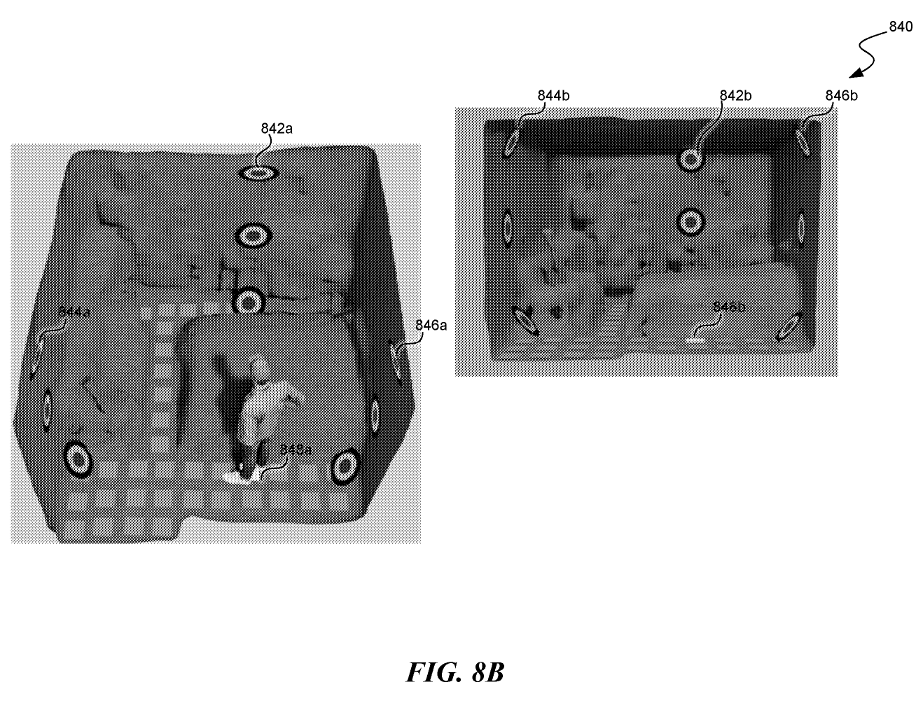

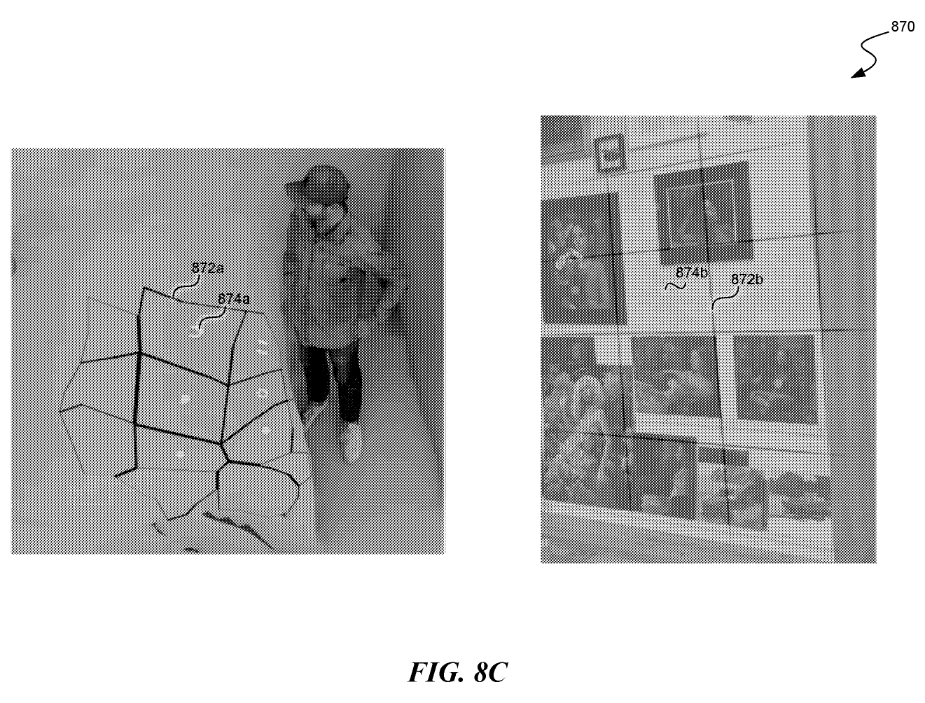

FIGS. 8A-8C are conceptual diagrams illustrating an example of capturing a physical space using multiple capture devices. A by-directional communication channel can be created between the phone and the HMD (e.g., using NFC, Wifi, Bluetooth, etc.) allowing synchronizing events from the phone to the HMD, to trigger events such as every time an image is taken. Additionally, the communication channel can provide guidance information displayed via the phone and event triggering from the HMD to the phone, such as starting a scan, or stopping and uploading the capture (e.g., while the HMD creates a Gaussian splat).

FIG. 8A is a conceptual diagram illustrating an example 800 of capturing a physical space using multiple capture devices. The view shows a three-dimensional mesh representation of a room environment that has been generated from scan data. A user avatar is shown within the generated environment for context. The environment includes visual indicators, such as an indicator 802 and a series of tiles 804 on the floor. These indicators 804 represent the progress of a scan, such as a perimeter scan of the room, for the user to travers with indicators 802 indicating each image for the user to capture when at one of the tiles 804. This figure illustrates a state of the environment generation process where an initial model has been created and is being analyzed or augmented.

FIG. 8B is a conceptual diagram illustrating another example 840 of capturing a physical space. The two views presented in example 840 show a 3D mesh of a room with a user avatar inside. The system has overlaid a series of circular targets (e.g., 842a, 844a, 846a, 848a and their counterparts in the second view) on the walls and floor of the rendered environment. These targets represent the specific areas of interest that the system has computationally identified as lacking sufficient detail from the initial scan, to be captured from a particular location (shown as tile 848a and 848b). By rendering these targets 842-846, corresponding to the user’s current tile location 848, the system provides clear and direct guidance to the user, instructing them precisely where to aim the camera of the mobile device to capture the required high-resolution images for updating and completing the XR environment.

FIG. 8C is a conceptual diagram illustrating an example 870 of capturing a physical space using fine-detail scanning patterns. The left view illustrates a checkerboard-like raster scanning pattern, where the system guides the user to capture a series of tiled images (e.g., 872a and 872b) across a large surface like a couch or a wall to ensure complete and even coverage – with indicators (e.g., 874a and 874b) indicating how well the images of that tile capture the corresponding region. This technique ensures that complex textures, reflections, and small details are captured with high fidelity, which are then used to generate a highly detailed and realistic representation of that object within the final XR environment.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., "non-transitory" media) and computer-readable transmission media.

Reference in this specification to "implementations" (e.g., "some implementations," "various implementations," “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase "selecting a fast connection" can be understood to mean selecting a connection that has a value assigned corresponding to its connection speed that is above a threshold.

As used herein, the word "or" refers to any possible permutation of a set of items. For example, the phrase "A, B, or C" refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

We claim:

1. A method for generating an extended reality environment using data from multiple devices, the method comprising:
performing an initial scan of a real environment using sensors from an extended reality device;
generating an initial extended reality environment from the initial scan;
defining regions, of the initial extended reality environment, that each require additional spatial and/or dimensional data;
identifying, based on the defined regions, multiple areas of interest to be captured by a mobile device;
receiving, from the mobile device, multiple images, each image associated with at least one of the multiple areas of interest; and
generating an updated extended reality environment based on the initial extended reality environment and the multiple images associated with the multiple areas of interest.

2. The method of claim 1, wherein the initial extended reality environment comprises a three-dimensional mesh.

3. The method of claim 1, wherein the initial extended reality environment comprises a Gaussian splat model.

4. The method of claim 1, wherein the extended reality device is a head mounted device (HMD).

5. The method of claim 1, wherein the sensors from the extended reality device comprise at least one of a camera, a depth sensor, or an inertial measurement unit (IMU).

6. The method of claim 1, further comprising causing guidance, for capturing the multiple images with the mobile device, to be provided to a user, wherein the guidance comprises at least one of a visual cue, an audible instruction, or a tactile feedback.

7. The method of claim 6, wherein the guidance comprises at least the visual cue, and wherein the visual cue comprises a virtual overlay rendered by the extended reality device indicating one of the multiple areas of interest.

8. The method of claim 1, further comprising synchronizing a spatial orientation of the extended reality device with the mobile device via a bi-directional communication channel.

9. The method of claim 1, wherein the mobile device is coupled, with a coupling component, to a controller during capture of the multiple images to facilitate guided capture of the multiple images.

10. The method of claim 9, wherein coupling the mobile device to the controller establishes a fixed spatial relationship, between a camera of the mobile device and the controller, based on specified dimensions of the coupling component.

11. The method of claim 1, wherein generating the updated extended reality environment comprises performing a data fusion operation to integrate the multiple images with the initial extended reality environment.

12. A computer-readable storage medium storing instructions, for generating an extended reality environment using data from multiple devices, the instructions, when executed by a computing system, cause the computing system to:
perform an initial scan of a real environment using sensors from an extended reality device;
generate an initial extended reality environment from the initial scan;
define regions, of the initial extended reality environment, that each require additional spatial and/or dimensional data;
identify, based on the defined regions, multiple areas of interest to be captured by a mobile device;
receive, from the mobile device, multiple images, each image associated with at least one of the multiple areas of interest; and
generate an updated extended reality environment based on the initial extended reality environment and the multiple images associated with the multiple areas of interest.

13. The computer-readable storage medium of claim 12, wherein the initial extended reality environment comprises a three-dimensional mesh.

14. The computer-readable storage medium of claim 12, wherein the initial extended reality environment comprises a Gaussian splat model.

15. The computer-readable storage medium of claim 12, wherein the extended reality device is a head mounted device (HMD).

16. The computer-readable storage medium of claim 12, wherein the sensors from the extended reality device comprise at least one of a camera, a depth sensor, or an inertial measurement unit (IMU).

17. The computer-readable storage medium of claim 12,
wherein the instructions, when executed, further cause the computing system to cause guidance, for capturing the multiple images with the mobile device, to be provided to a user; and
wherein the guidance comprises at least a visual cue that comprises a virtual overlay rendered by the extended reality device indicating one of the multiple areas of interest.

18. The computer-readable storage medium of claim 12, wherein the instructions, when executed, further cause the computing system to synchronize a spatial orientation of the extended reality device with the mobile device via a bi-directional communication channel.

19. The computer-readable storage medium of claim 12,
wherein the mobile device is coupled, with a coupling component, to a controller during capture of the multiple images to facilitate guided capture of the multiple images; and
wherein coupling the mobile device to the controller establishes a fixed spatial relationship, between a camera of the mobile device and the controller, based on specified dimensions of the coupling component.

20. A computing system for generating an extended reality environment using data from multiple devices, the computing system comprising:
one or more processors; and
one or more memories storing instructions that, when executed by the one or more processors, cause the computing system to:
perform an initial scan of a real environment using sensors from an extended reality device;
generate an initial extended reality environment from the initial scan;
define regions, of the initial extended reality environment, that each require additional spatial and/or dimensional data;
identify, based on the defined regions, multiple areas of interest to be captured by a mobile device;
receive, from the mobile device, multiple images, each image associated with at least one of the multiple areas of interest; and
generate an updated extended reality environment based on the initial extended reality environment and the multiple images associated with the multiple areas of interest.
